(19) United States
(12) Patent Application Publication
(10) Pub. No.: US 2024/0217006 A1
(43) Pub. Date: Jul. 4, 2024

(54) CHUCK, CUTTING TOOL, AND ASSEMBLY

(71) Applicant: Kennametatal Inc., Latrobe, PA (US)

(72) Inventors: Michael Schuffenhauer, Fuerth (DE); Georg Roth, Fuerth (DE); Patrick Kuhlemann, Fuerth (DE)

(21) Appl. No.: 18/286,622

(22) PCT Filed: Apr. 13, 2022
(86) PCT No.: PCT/EP22/59894

§ 371 Date: Oct. 12, 2023

(30) Foreign Application Priority Data
Apr. 13, 2021 (DE) 10202109226.4

(51) Int. Cl. B23B 31/30; B23B 31/00; B23B 31/107; B23B 31/11

(52) U.S. Cl. CPC B23B 31/305; B23B 31/005; B23B 31/1075; B23B 31/11

(57) ABSTRACT

An assembly comprises: a chuck, which has a tool-receiving socket, a contact surface, and a screw thread; and a cutting tool, which has a tool shaft, a mating contact surface, and a mating screw thread. In a clamped state, the mating screw thread of the cutting tool is screwed into the screw thread of the chuck, the mating contact surface of the cutting tool is seated against the contact surface of the chuck, and the tool shaft is frictionally torque-transmittingly clamped in the tool-receiving socket. The invention also relates to a chuck of this type and to a cutting tool of this type.

The invention relates to a chuck, which has a tool-receiving socket, and a cutting tool, which has a tool shaft provided in order to be clamped in the tool-receiving socket of such a chuck. Furthermore, the invention relates to an assembly comprising such a chuck and such a cutting tool.

Chucks having a tool-receiving socket as well as cutting tools having a tool shaft are known.

Such cutting tools are clamped with their tool shaft in the tool-receiving socket of the chuck in order to secure the cutting tools to the chuck and to thus ensure a defined machining of a workpiece by means of the cutting tool. In particular in the case of rotary cutting tools, such as drills, the cutting tool and the chuck are connected in a torque-transmitting manner.

However, such assemblies of cutting tool and chuck are only suitable to a limited extent for certain applications. For example, due to the shape of the workpieces, such as T beams and double-T steel beams, the machining of structural steel requires comparatively long drills as the cutting tool. The vibrations occurring in these assemblies during the cutting process results in a reduced lifetime of the drill and bores with reduced quality.

The problem addressed by the invention is to provide a chuck as well as a cutting tool that ensure a defined cutting process and favor a long lifetime even under high specifications, such as the machining of construction steel.

The problem is solved by a chuck for a cutting tool, which has a tool-receiving socket in which a tool shaft of the cutting tool can be clamped in a radial direction, a contact surface for a mating contact surface of the cutting tool, and a screw thread designed so as to be coaxial with the tool-receiving socket and into which a mating screw thread of the cutting tool can be screwed.

The problem is further solved by a cutting tool, which has a tool shaft provided so as to be clamped in a tool-receiving socket of a chuck according to the invention, a mating contact surface provided so as to make contact with a contact surface of a chuck according to the invention, and a mating screw thread provided so as to be screwed into a screw thread of a chuck according to the invention.

Furthermore, the problem is solved by an assembly comprising a chuck according to the invention and a cutting tool according to the invention. The mating screw thread of the cutting tool is screwed into the screw thread of the chuck, the mating contact surface of the cutting tool is seated against the contact surface of the chuck, and the tool shaft is frictionally torque-transmittingly clamped in the tool-receiving socket.

According to the present invention, it has been discovered that the stability of the cutting tool during a cutting process can be improved when, in addition to the torque-transmitting coupling with the chuck, the cutting tool is strained with the chuck in the axial direction. Due to the fact that the cutting tool is screwed to the chuck via the screw thread and mating screw thread, it is ensured that the mating contact surface of the cutting tool and the contact surface of the chuck are seated tightly against one another. The mating contact surface of the cutting tool and the contact surface of the chuck act as support surfaces that stabilize the cutting tool and thus suppress vibrations. In this way, particularly precise cutting processes can be performed using the assembly. Furthermore, this favors a particularly long service life of the cutting tool. Because the torque transmission is accomplished by means of the tool-receiving socket, the screw thread is prevented from being excessively tightened. This prevents wear and ensures that the cutting tool can be easily exchanged.

The cutting tool is in particular a cutting tool that rotates during the cutting process.

In one embodiment, the contact surface is arranged on an end face of the chuck, thereby ensuring effective contact with the mating contact surface, in particular at a location that is particularly close to the workpiece or a tip of the cutting tool during a cutting process, so that the cutting tool is effectively stabilized.

Furthermore, it can be provided that the screw thread is arranged at the bottom of the tool-receiving socket. This has the advantage that the cutting tool can be screwed to the chuck with little effort, because the remaining portion of the tool-receiving socket can guide the tool shaft. Furthermore, with this design, the screw thread is particularly well protected in the chuck.

In a further embodiment, the chuck is configured as an expansion chuck, whereby the cutting tool can be reliably torque-transmittingly clamped in the chuck with little effort.

According to an alternative embodiment, the chuck comprises mechanically actuatable clamping elements, by means of which the cutting tool can be reliably torque-transmittingly coupled to the chuck in the tool-receiving socket.

Furthermore, the tool shaft can have, at least in portions, a cylindrical outer surface. This design ensures that the cutting tool is in particular effectively torque-transmittingly connected to the chuck. Furthermore, a cylindrical tool shaft is particularly stable and inexpensive to manufacture.

According to a further embodiment, the screw thread is arranged at the end of the tool shaft. In this way, during a cutting process, the cutting tool is screwed to the chuck at a location that is particularly far removed from the workpiece, whereby the cutting tool is effectively stabilized.

Additionally or alternatively, the mating contact surface can be arranged between the tool shaft and a cutting portion of the cutting tool. The cutting tool is thereby in particular effectively stabilized, because the mating contact surface is thus arranged particularly close to the workpiece during a cutting process and can thus in particular effectively absorb transverse forces that act on a cutting portion of the cutting tool.

Further advantages and features will emerge from the following description and from the accompanying drawings. The figures show:

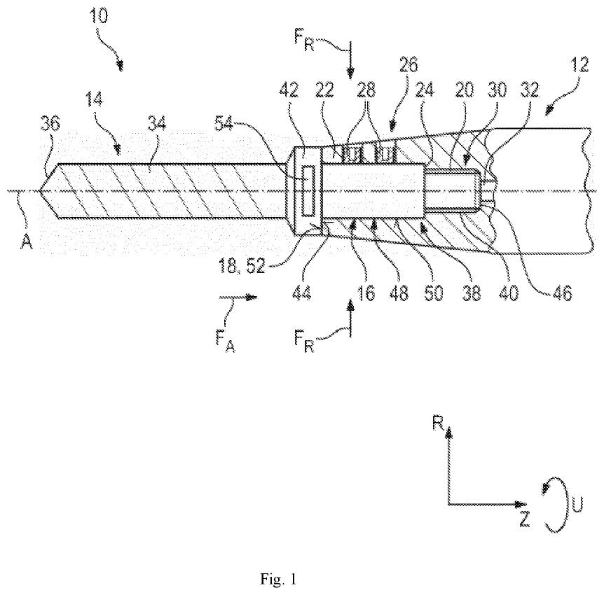

FIG. 1 in a schematic side view, an assembly according to the invention with a cutting tool according to the invention and a chuck according to the invention, which is partially shown in a sectioned view, and

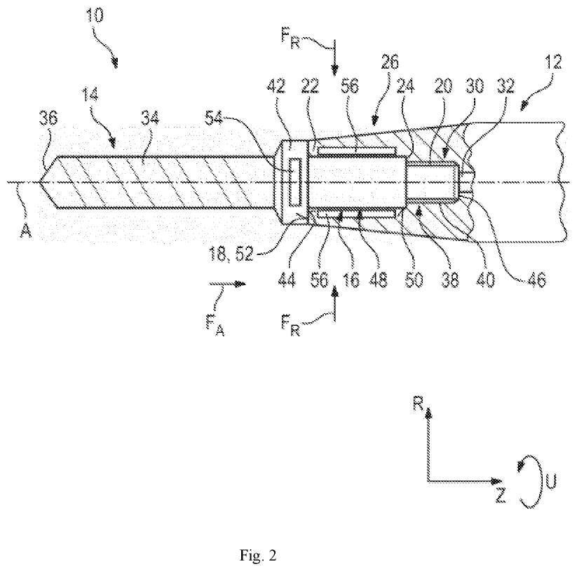

FIG. 2 in a schematic side view, an assembly according to the invention with the cutting tool from FIG. 1 and a chuck according to the invention according to a further embodiment, which is partially shown in a sectioned view.

FIG. 1 shows an assembly 10 comprising a chuck 12 and a cutting tool 14. In FIG. 1, the assembly 10 is shown in a clamped state, that is to say that the cutting tool 14 is clamped in the chuck 12 for machining a workpiece, as will be explained in greater detail later.

The chuck 12 has a tool-receiving socket 16, a contact surface 18, and a screw thread 20.

The tool-receiving socket 16 extends in the axial direction Z from an axial end 22 of the chuck 12 to a bottom 24 of the tool-receiving socket 16.

In the illustrated embodiment, the tool-receiving socket 16 is designed so as to be circular cylindrical as well as coaxial to the axis A.

The portion of the chuck 12 adjacent to the tool-receiving socket 16 forms a clamping portion 26 in which the cutting tool 14 is clamped.

The clamping portion 26 comprises two mechanically actuatable clamping elements 28 in the form of two clamping screws, which extend into the tool-receiving socket 16 in the radial direction R.

In principle, the chuck 12 can comprise any kind of clamping elements 28, in particular any number of mechanically actuatable clamping elements 28, and/or any number of clamping elements 28.

The screw thread 20 adjoins the bottom 24 of the tool-receiving socket 16 in the axial direction Z, which is designed so as to be coaxial to the axis A and forms a threaded portion 30 of the chuck 12.

For example, the passage 32 adjacent to the threaded portion 30 is a coolant passage for cooling lubricant and can be omitted in other embodiments.

The cutting tool 14 has a cutting portion 34 with a tip 36, a tool shaft 38 with a mating screw thread 40, and a collar 42 with a mating contact surface 44 formed in the axial direction Z between the cutting portion 34 and the tool shaft 38.

In the illustrated embodiment, the cutting tool 14 is a rotating cutting tool in the form of a spiral drill for machining construction steel.

In principle, the cutting tool 14 can be any kind of cutting tool, in particular any kind of drill, a modular drill, or an indexable drill.

Furthermore, the cutting tool 14 can comprise one or more coolant passages for cooling lubricants.

From an axial end 46 of the tool shaft 38 arranged opposite the tip 36, the mating screw thread 40 extends counter to the axial direction Z in the direction of the collar 42.

In principle, the mating screw thread 40 can be arranged at any location on the cutting tool 14, in particular any location on the tool shaft 38.

In all embodiments, the mating screw thread 40 is designed so as to be complementary to the screw thread 20 of the chuck 12 as well as coaxial to the axis A.

The tool shaft 38 comprises a retaining portion 48, which is designed so as to be coaxial to the axis A and, in the present embodiment, is arranged between the mating screw thread 40 and the collar 42.

The retaining portion 48 is designed here in a circular cylindrical manner, with a cylindrical outer surface 50, as well as being complementary to the tool-receiving socket 16.

In principle, the retaining portion 48 can have any design, in particular any cylindrical shape.

The contact surface 18 and the mating contact surface 44 are designed so as to be complementary to one another so that the mating contact surface 44 is seated in a planar manner against the contact surface 18 in the clamped state.

In the illustrated embodiment, the contact surface 18 and the mating contact surface 44 each extend in the radial direction R as well as perpendicular to the axial direction Z.

Furthermore, the contact surface 18 and the mating contact surface 44 each extend in an annular manner in a circumferential direction U about the axis A, whereby, in the clamped state, a contact of the mating contact surface 44 with the contact surface 18 over the entire circumference, i.e., over 360° in the circumferential direction U, is ensured.

The contact surface 18 is formed on an end face 52 at the axial end 22 of the chuck 12 and is thus arranged particularly close to the tip 36 of the cutting tool 14.

In principle, the contact surface 18 and the mating contact surface 44 can have any design and/or can be configured at any location on the chuck 12 or on the cutting tool 14, as long as it is ensured that the contact surface 18 and the mating contact surface 44 are seated against one another while being clamped in the axial direction Z.

To clamp the chuck 12 in the cutting tool 14, in a first step, the tool shaft 38 is inserted into the tool-receiving socket 16 in the axial direction Z, and the mating screw thread 40 is screwed onto the screw thread 20 in the threaded portion 30.

The cutting tool 14 is screwed into the chuck 12 until the mating contact surface 44 is seated in a planar manner against the contact surface 18 under an axial force FA.

In this context, the cutting tool 14 comprises tool-engaging surfaces 54, which, in the present embodiment, are provided on the collar 42 in order to, for example, be able to strain the cutting tool 14 with the chuck 12 in the axial direction Z in a defined manner by means of a wrench while applying a specific torque.

In a subsequent step, the clamping elements 28 are tightened, and thus the clamping portion 26 is strained with the retaining portion 48 in the radial direction R under a radial force FR, whereby the cutting tool 14 is frictionally torque-transmittingly coupled to the chuck 12.

An assembly 10 according to a further embodiment will now be described on the basis of FIG. 2. For the components known from the above embodiment, the same reference numerals are used, and reference is made in this respect to the above explanations.

Unlike the assembly 10 shown in FIG. 1, the assembly 10 shown in FIG. 2 has a chuck 12 with a clamping portion 26 designed as an expansion chuck.

For this purpose, instead of the clamping elements 28, the clamping portion 26 comprises pressure chambers 56, which can be pressurized with a fluid in a known manner in order to strain the retaining portion 48 in the clamping portion 26 in the radial direction R under a radial force FR and thus frictionally torque-transmittingly couple the cutting tool 14 to the chuck 12.

In this way, a chuck 12, a cutting tool 14, and an assembly 10 are provided, which ensure a defined cutting process.

Due to the fact that the cutting tool 14 is screwed to the chuck 12 in the clamped state and supports itself on the contact surface 18 via the mating contact surface 44, the cutting tool 14 is in particular stabilized against bending torques acting on the cutting portion 34. Thus, it is effectively suppressed that the center of the cutting portion 34 travels away from the axis A during the cutting process, thereby allowing particularly high-quality bores to be cut.

The improved run-out also favors a long tool life of the cutting tool 14.

The design of the assembly 10 further has the advantage that the cutting tool 14 can be strained with the chuck 12 and detached therefrom with little effort.

The invention is not limited to the embodiments shown. Individual features of one embodiment can in particular be combined as desired with features of other embodiments, in particular independently of the other features of the corresponding embodiments.

1. A chuck for a cutting tool, which has a tool-receiving socket in which a tool shaft of the cutting tool can be clamped in a radial direction, a contact surface for a mating contact surface of the cutting tool, and a screw thread designed so as to be coaxial with the tool-receiving socket and into which a mating screw thread of the cutting tool can be screwed.

2. The chuck according to claim 1, characterized in that the contact surface is arranged on an end face of the chuck.

3. The chuck according to claim 1, characterized in that the screw thread is arranged at the bottom of the tool-receiving socket.

4. The chuck according to claim 1, characterized in that the chuck is configured as an expansion chuck.

5. The chuck according to claim 1, characterized in that the chuck comprises mechanically actuatable clamping elements.

6. A cutting tool, which has a tool shaft provided so as to be clamped in a tool-receiving socket of a chuck according to claim 1, a mating contact surface provided so as to make contact with a contact surface of a chuck according to claim 1, and a mating screw thread provided so as to be screwed into a screw thread of a chuck according to claim 1.

7. The cutting tool according to claim 6, the tool shaft has, at least in portions, a cylindrical outer surface.

8. The cutting tool according to claim 6, the screw thread is arranged at the end of the tool shaft.

9. The cutting tool according to claim 6, the mating contact surface is arranged between the tool shaft and a cutting portion of the cutting tool.

10. An assembly comprising:
a chuck for a cutting tool which has a tool-receiving socket in which a tool shaft of the cutting tool can be clamped in a radial direction, a contact surface for a mating contact surface of the cutting tool, and a screw thread designed so as to be coaxial with the tool-receiving socket and into which a mating screw thread of the cutting tool can be screwed; and
a cutting tool which has a tool shaft provided so as to be clamped in a tool-receiving socket of the chuck, a mating contact surface provided so as to make contact with a contact surface of a chuck, and a mating screw thread provided so as to be screwed into a screw thread of the chuck,
characterized in that the mating screw thread of the cutting tool is screwed into the screw thread of the chuck, the mating contact surface of the cutting tool is seated against the contact surface of the chuck, and the tool shaft is frictionally torque-transmittingly clamped in the tool-receiving socket.

11. The assembly of claim 10, characterized in that the contact surface is arranged on an end face of the chuck.

12. The assembly of claim 10, wherein the tool shaft has, at least in portions, a cylindrical outer surface

13. The chuck according to claim 2, characterized in that the screw thread is arranged at the bottom of the tool-receiving socket.

14. The chuck according to claim 2, characterized in that the chuck is an expansion chuck.

15. The chuck according to claim 3, characterized in that the chuck is an expansion chuck.

16. The chuck according to claim 2, characterized in that the chuck comprises mechanically actuatable clamping elements.

17. The chuck according to claim 3, characterized in that the chuck comprises mechanically actuatable clamping elements.

18. The cutting tool according to claim 7, the screw thread is arranged at the end of the tool shaft.

19. The cutting tool according to claim 7, the mating contact surface is arranged between the tool shaft and a cutting portion of the cutting tool.

20. The cutting tool according to claim 8, the mating contact surface is arranged between the tool shaft and a cutting portion of the cutting tool.
